(19) United States
(12) Patent Application Publication
(10) Pub. No.: US 2020/0053500 A1
(43) Pub. Date: Feb. 13, 2020

(54) Information Handling System Adaptive Spatialized Three Dimensional Audio

(71) Applicant: Dell Products L.P., Round Rock, TX (US)

(72) Inventor: Thanh T. Tran, Houston, TX (US)

(73) Assignee: Dell Products L.P., Round Rock, TX (US)

(21) Appl. No.: 16/057,917

(22) Filed: Aug. 8, 2018

(51) Int. Cl. H04S 7/00; H04R 5/02; H04R 5/04; G06K 9/00; H04S 3/00

(52) U.S. Cl. CPC H04S 7/303; H04R 5/02; H04R 5/04; H04S 2400/11; H04S 3/008; H04R 2499/15; G06K 9/00228

(57) ABSTRACT

A portable information handling system presents stereo audio information oriented relative to visual information in landscape and portrait orientations by disposing a speaker in each of four housing corners so that both landscape and portrait orientations have a speaker in each of the left and right locations. An audio system directs left and right audio to an appropriate speaker based upon visual information orientation while leveraging other speakers to provide three dimensional audio effects.

### BACKGROUND OF THE INVENTION

### Field of the Invention

The present invention relates in general to the field of information handling system audiovisual presentation, and more particularly to an information handling system adaptive spatialized three dimensional audio.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often present audiovisual information to end users. For example, one common use of information handling systems is to play videos retrieved from a network location, such as streaming of entertainment or presenting video conferences. Information handling systems interact with a large variety of displays to present audiovisual information. Standardized cable and wireless interfaces, such as HDMI, allow information handling systems to present audiovisual information at full sized television displays or desktop peripheral displays. In portable information handling systems, a display is often integrated in an information handling system housing to support presentation of audiovisual information without hardwire connections. End users will often present audiovisual information on tablet information handling systems that have a display integrated in an upper surface of a planar housing. In some instances, portable telephones act as tablet information handling system to present audiovisual information.

Audiovisual information typically presents synchronized audio with movie visual images, such as talking voices and background noise. Often, audio is played with stereo effects that provide a direction from which the audio appears to come. For example, basic stereo sounds play left and right audio on left and right speakers so that the end user hears the audio from a desired direction, such as the side of the display having a visual event associated with the audio. To accomplish stereo effects, audio is stored in left and right channels so that the information handling system passes the left and right channels of audio information to left and right speakers for playback. In some instances, external speakers may provide audio from multiple directions with multiple channels. For example, 2.1 stereo sound includes left and right channels plus bass audio through a subwoofer, while 5.1 stereo sound provides surround sound with channels that feed to speakers located behind a viewer. Generally, portable information handling systems that have left and right speakers will support left and right stereo channels while in a portable mode. In some instances, surround sound or other types of audio may be supported with communication of the audio information to an external amplifier and speaker system.

One difficulty that arises with the use of surround sound in portable information handling systems is that end users may orient the housing and speakers in unexpected manners. For example, end users may rotate the housing and integrated display 90 degrees so that speakers align vertically instead of horizontally relative to the end user. Vertical alignment creates an audio separation problem in which the left and right audio channels become top and bottom audio sources relative to the visual images instead of left and right audio sources.

### SUMMARY OF THE INVENTION

Therefore, a need has arisen for a system and method which adapts stereo sound to horizontal and vertical alignment of speakers that present the stereo sound.

In accordance with the present invention, a system and method are provided which substantially reduce the disadvantages and problems associated with previous methods and systems for presenting stereo audio information synchronized with visual information at a portable information handling system that rotates between horizontal and vertical alignments. Plural speakers disposed at the perimeter of the information handling system housing align a first speaker for left audio and a second speaker for right audio to present audio information in each of plural visual orientations, such as landscape and portrait orientations of the display. Extra speakers that support visual orientations not in use can present spatialized three dimensional sounds when not selected to present left or right audio, such as by generating reverbs that emulate three dimensional sounds.

More specifically, an information handling system presents audiovisual information as visual images presented at a display and audible sounds presented at plural speakers, such as movie or videoconference. Orientation sensors detect an orientation of the information handling system to determine a visual orientation for presentation of the visual images. For example, an accelerometer or an Earth magnetic sensor detects a vertical axis relative to Earth and presents visual information aligned with the vertical axis on the assumption that an end user viewing the visual image is upright. Alternatively, a camera captures a visual image of an end user viewing the display and analyzes eye tracking or other facial features of the captured image to determine a vertical axis for visual orientation. Upon detection of rotation of the information handling system, an audio system directs left and right audio to appropriate speakers based upon the visual orientation, and in one embodiment, also directs left and right spatialized three dimensional audio to appropriate other speakers that are not presenting left and right audio. In one embodiment, the audio system determines an audio orientation independent of the visual orientation so that right and left audio is presented in a desired manner based upon end user location information. In one embodiment, monoaural presentation of audio information instead of left and right stereo presentation may be used when an audio orientation is indefinite or has multiple possible axes.

The present invention provides a number of important technical advantages. One example of an important technical advantage is that an information handling system presents left and right audio aligned with a visual presentation in both landscape and portrait orientations. To achieve left and right audio in both landscape and portrait orientations, a speaker is included in each corner of the information handling system housing so that a left and right speaker are both available in each housing orientation. Speakers that are not aligned in a location that aids presentation of left and right audio may be used to enhance the audio experience, such as by presenting locally-generated spatialized three dimensional audio. Visual and audio presentation of information may be supported along independent axes and audio presentation may include monoaural presentation where left and right audio orientation becomes uncertain or different for plural end users observing visual information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exploded view of an information handling system configured to present left and right audio information in landscape and portrait orientations;

FIG. 2 depicts an end user viewing the information handling system in landscape orientation with left and right audio presented at lower left and right corners of the information handling system;

FIG. 3 depicts an end user viewing the information handling system in portrait orientation with left and right audio presented at lower left and right corners of the information handling system;

FIG. 4 depicts a block diagram of an audio system that presents audio information based upon an audio orientation; and

FIG. 5 depicts a flow diagram of a process for determining audio presentation orientation.

### DETAILED DESCRIPTION

An information handling system presents left and right audio from the respective direction relative to an end user as the user rotates the housing between landscape and portrait orientations. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

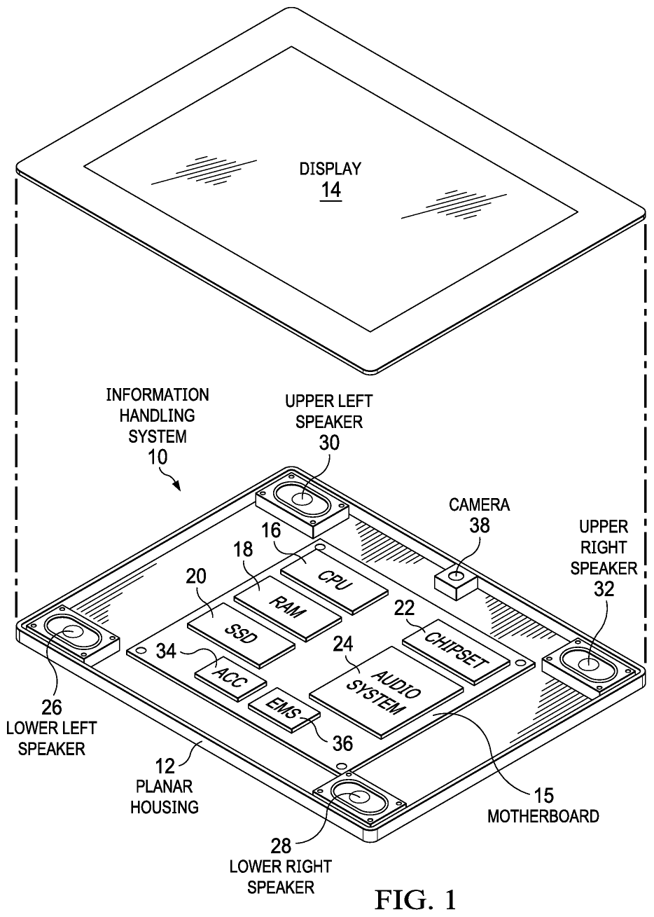

Referring now to FIG. 1, an exploded view depicts an information handling system 10 configured to present left and right audio information in landscape and portrait orientations. Information handling system 10 is built within a planar housing 12 that has a tablet configuration exposing a display 14 over a top surface that presents visual images. In the example embodiment, a motherboard 15 disposed in planar housing 12 interfaces plural processing components that cooperate to generate visual images for presentation at display 14. For instance, a central processing unit (CPU) 16 executes instructions stored in random access memory (RAM) 18, such as instructions of an operating system or application retrieved from persistent storage of a solid state drive (SSD) 20. CPU 16 generates visual information that is processed into pixel values by a graphics processor integrated in chipset 22. Generally, chipset 22 includes a variety of hardware and firmware components, such as embedded code stored in non-transient flash memory, which coordinates input and output information, such as through touches at a touchscreen, keyboard inputs, mouse inputs, touchpad inputs and presentation of visual images. In various embodiments, various arrangements of hardware, firmware and software components may be used to coordinate inputs and outputs, such as an independent graphics processor that processes pixel information and wireless interfaces that interact with external peripherals.

In the example embodiment, an audio system 24 receives audio information from CPU 16 and presents the audio information as audible sounds at plural speakers 26-32. For example, audio information is synchronized with visual information when presenting audiovisual files, such as movies or video conferences. As another example, audio files are presented independent of visual information, such as music recordings and telephone conversations. In some instances, audio information has a monoaural configuration, meaning that a single audio channel outputs the same audio signal at each speaker 26-32. In other instances, audio information has plural audio channels that present audio information at a location relative to a listener of the audio information. For example, two channel stereo provides left and right audio signals for presentation at left and right locations relative to a listener. In the example embodiment, display 14 is oriented on housing 12 to have a landscape orientation while presenting two channel stereo information having a left channel played at lower left speaker 26 and a right channel played at a lower right speaker 28. Generally, a landscape orientation has a greater length relative to a viewer of display 14 along a horizontal X axis than a vertical Y axis. Typically, commercial movies are created in a landscape orientation for presentation on standardized displays, such as with HDMI or 4K resolutions. However, with a portable planar housing 12, an end user may rotate housing 12 90 degrees to a portrait orientation having a greater length relative to a viewer of display 14 along a horizontal X axis than a vertical Y axis. In such an instance, the visual information is typically presented at a lower resolution at only a portion of display 14, such as by leaving a blank portion above and below the presented visual information. Various conventional information handling systems use various Earth reference orientation sensor to determine whether to present visual information in a portrait or landscape orientation at display 14, such as an accelerometer 34 that detects gravitational force or an Earth magnetic sensor that detects the Earth's magnetic field. For instance, an operating system interfaces with the orientation sensors to determine a visual image orientation for presentation at display 14, such as landscape or portrait orientation.

In the example embodiment, audio system 24 interfaces with orientation sensors, such as through an operating system or application executing on CPU 16, to determine an audio orientation for presentation of audio information at speakers 26-32. For instance, with a visual orientation having a landscape orientation so that lower left speaker 26 is located to the lower left of visual images presented on display 14, left audio is presented at lower left speaker 26 and right audio is presented at lower right speaker 28. In the example embodiment, upper left speaker 30 and upper right speaker 32 may operate in a variety of modes that enhance audio presentation to the end user. For instance, upper left speaker 30 presents left spatialized three dimensional audio generated locally at audio system 24 by subtracting left audio from right audio and delays the difference to create a three dimensional reverb effect. Similarly, upper right speaker 32 presents right spatialized three dimensional audio generated locally at audio system 24 by subtracting right audio from left audio and delaying the difference to create a three dimensional reverb effect. In alternative embodiments, upper speakers 30 and 32 may provide alternative outputs, such as by remaining silent, outputting the same left and right audio output by the lower speakers or providing bass effects.

In the example embodiment, audio system 24 changes the selection of speakers to present left and right audio as planar housing rotates from the landscape to the portrait orientation. For example, a clockwise rotation of housing 12 places speaker 28 in a lower left position so that audio system 24 plays left audio at speaker 28 instead of right audio. Similarly, rotation of housing 12 places speaker 32 in a lower right position so that audio system 24 plays right audio at speaker 32. After 90 degrees of clockwise rotation, speaker 26 and 30 are located in upper left and right positions respectively to play left and right spatialized audio respectively. An additional 90 degrees of clockwise rotation puts housing 12 is a landscape orientation upside down relative to the original orientation. In one embodiment, audio assignments are shifted counterclockwise as describe above so that upper right speaker 32 presents left audio and upper left speaker 30 presents right audio with speakers 26 and 28 presenting spatialized audio. In an alternative embodiment, left and right audio may shift to speakers located at the top of the visual orientation so that in an inverted landscape orientation plays right audio from speaker 26 and left audio from speaker 28. Advantageously, in portrait orientations one of the upper speakers 30 or 32 is available to support left and right audio so that the end user has correct stereo playback. As is set forth in greater detail below, camera 38 aligns to capture an image of a viewing area in front of display 14, such as facial features of an end user, so that audio orientation may be performed based upon a user's actual facial orientation instead of simply relying upon a visual orientation used by display 14.

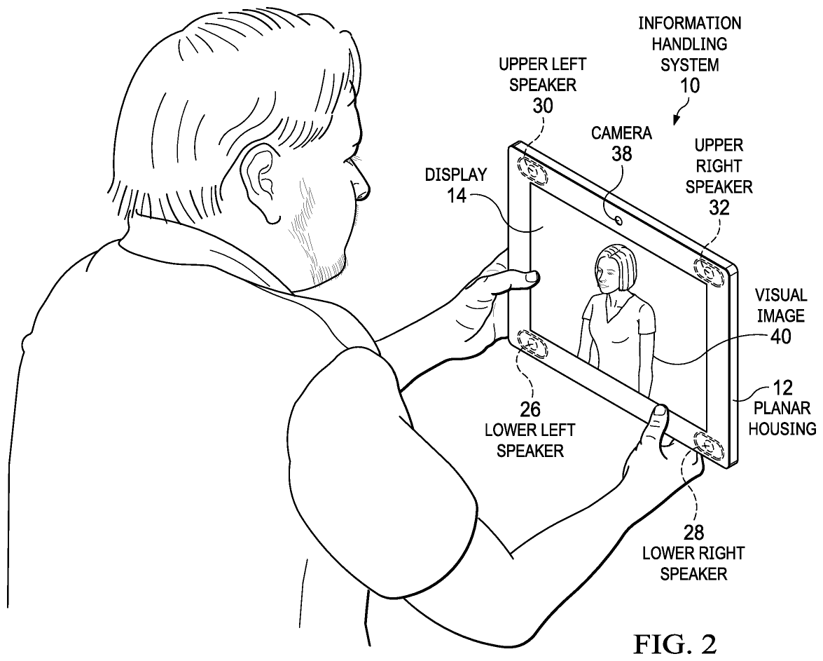

Referring now to FIG. 2, an end user views information handling system 10 in landscape orientation with left and right audio presented at lower left and right corners of information handling system 10. A visual image 40 is presented in the landscape orientation to appear upright to the end user, who is holding planar housing 12 in the landscape orientation relative to gravity. Camera 38 captures an image of the end user to analyze the position of facial features relative to speakers 26 and 28, such as the relative location of the user's mouth and nose. An analysis of the user's relative audio orientation separate from the visual presentation orientation provides correct stereo effects relative to the end user independent of the visual presentation orientation. Alternatively, the visual and audio orientations may be forced to coincide, such as based upon a user's selection to lock a visual orientation with a manual setting.

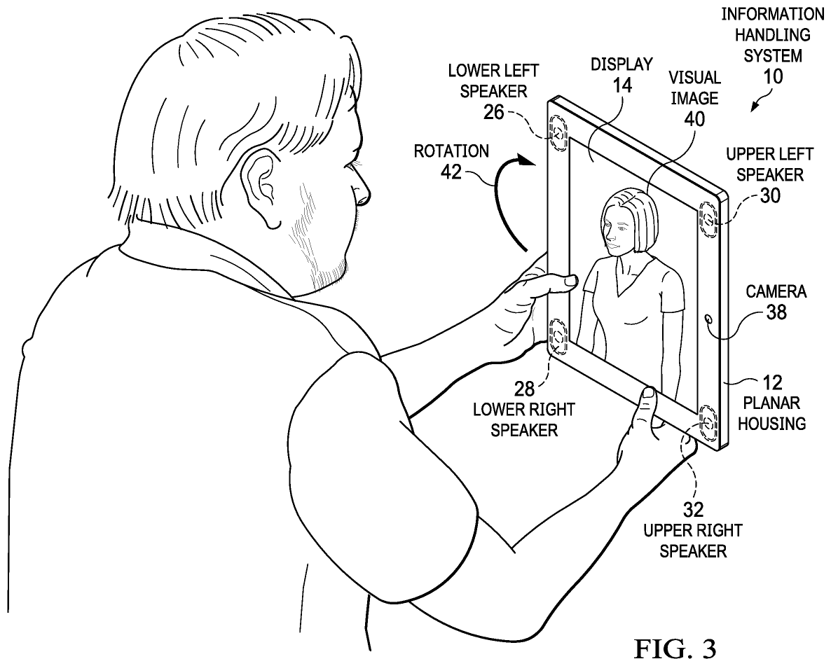

Referring now to FIG. 3, an end user views information handling system 10 in portrait orientation with left and right audio presented at lower left and right corners of information handling system 10. As indicated by arrow 42, housing 12 rotates 90 degrees clockwise to the portrait orientation, resulting in a change of presentation of visual image 40. Having a speaker in each corner of housing 12 ensures that a speaker will always align to a right and left audio position as visual image 40 presents at display 14. Additional speakers that are not aligned to present left and right audio may be utilized to present three dimensional effects or otherwise play audio sounds appropriate for the situation. The example embodiment places four speakers in four separate corners of a rectangular housing 12, however, in alternative embodiments, alternative arrangements of speakers and alternative housing shapes may be used. Generally, as visual images shift in presentation orientation relative to housing 12, audio information shifts so that the end user hears stereo from desired directions, such as synchronized with the audio information.

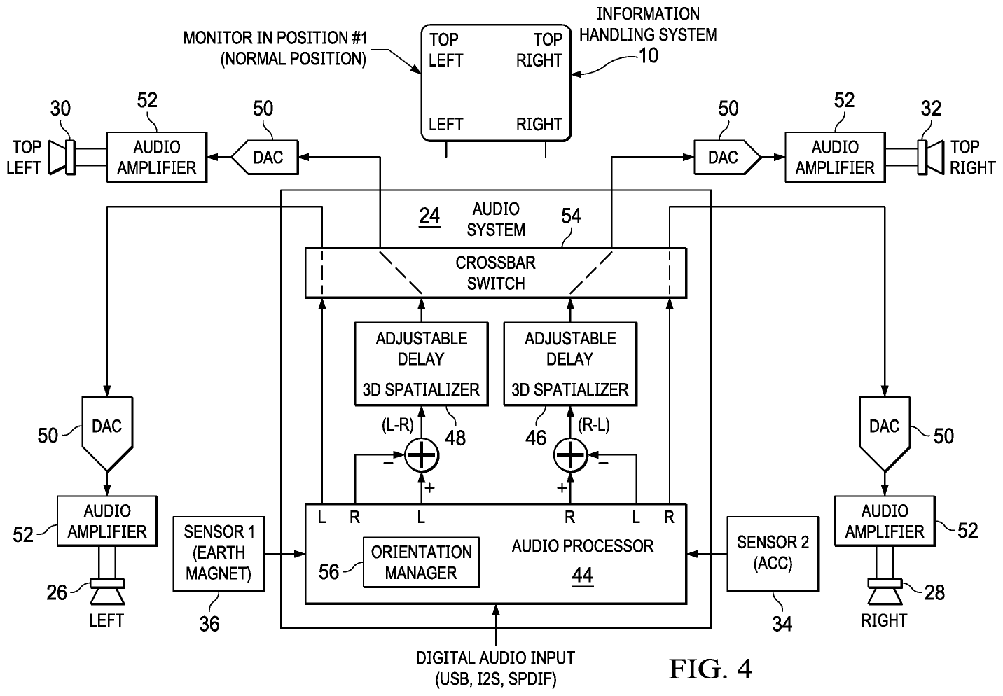

Referring now to FIG. 4, a block diagram depicts an audio system 24 that presents audio information based upon an audio orientation. In the example embodiment, audio system 24 includes an audio processor 44 that accepts audio information from an operating system or application and processes the audio information to generate audio signals in left and right stereo channels. For example, a stream of audio information in digital format is provided to a digital-to-analog converter (DAC) 50 to create analog signals amplified by an audio amplifier 52 and played by a speaker 26-32. In an alternative embodiment, audio processor 44 may generate analog signals that are directed to each of speakers 26-32 for presentation. In the example embodiment, audio processor 44 outputs left and right audio to an adder and adjustable delay circuit 46 and 48 for creation of spatialized three dimensional audio to play at speakers not associated with left and right audio signals. In alternative embodiments, alternative types of audio signals may be provided to the speakers that do not play left or right audio. An orientation manager 56 executing in audio processor 44 receives orientation information from orientation sensors 34 and 36, and applies the orientation information to control which speakers present which audio stream by controlling a crossbar switch 54. In alternative embodiments, other types of hardware controls may be used, such as multiplexor/demultiplexor.

In the example embodiment, orientation manager 56 commands crossbar switch 54 to switch audio between speakers 26-32 based upon a detected orientation so that left and right audio plays on the correct speakers for detected audio orientation. The dotted lines across crossbar switch 54 illustrate how audio information is switched in the landscape orientation depicted by FIG. 2, with left audio to speaker 26, right audio to speaker 28, left spatialized audio to speaker 30 and right spatialized audio to speaker 32. Upon 90 degrees of clockwise rotation of the audio orientation to a portrait orientation as depicted by FIG. 3, left audio switches to speaker 28, right audio to speaker 32, left spatialized audio to speaker 26 and right spatialize audio to speaker 30. An additional 90 degrees of clockwise rotation to an inverted landscape orientation inverts the left and right audio presentation so that left audio is played on speaker 32 and right audio is played on speaker 30, with left spatialized audio played on speaker 28 and right spatialized audio played on speaker 26. At 270 degrees of rotation, crossbar switch 54 play right audio on speaker 26, left audio on speaker 30, right spatialize audio on speaker 28 and left spatialized audio on speaker 32.

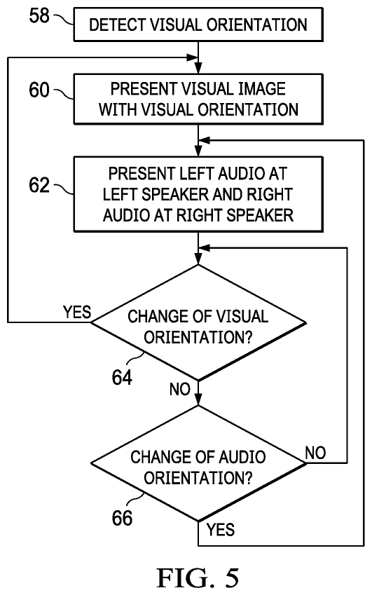

Referring now to FIG. 5, a flow diagram depicts a process for determining audio presentation orientation. At step 58, visual orientation is detected, such as by detecting an upright axis relative to gravity, and at step 60 visual images are presented with the visual orientation. For example, conventional operating system control over visual presentation as landscape or portrait visual images is applied and reported to the audio system so that the audio system may synchronize audio presentation stereo directions with the visual image, such as left stereo on the left side of a visual image presented upright and right stereo on the right side of a visual image presented upright. Alternatively, audio orientation may be determined separately from visual orientation so that audio information is presented upright relative to an audio “upright” position of an end user, such as by analyzing an image of an end user relative to the information handling system or listening for the end user location with directional microphones.

At step 62 left audio is presented at a left speaker relative to the audio orientation and right audio is presented at a right speaker relative to the audio orientation. Once audio is presented, monitoring follows to determine if a change in audio orientation warrants a change in the speakers that play the audio sound. At step 64, a determination is made of whether a change of visual orientation has occurred, such as with a rotation of the housing that changes the visual orientation of visual images presented at the display. If so, the process returns to step 60 to present the visual images with the visual orientation and the audio information with an audio orientation associated with the visual orientation. In one embodiment, a delay is applied after detection of a change in visual orientation to ensure that the new visual orientation is selected long enough to warrant a change of presentation of visual images. In some instances, the delay for selection of audio orientation may be longer or shorter than the delay associated with selection of visual orientation. For example, audio channel switching to a new channel may be supported more quickly than visual orientation changes. Alternatively, audio changes may be delayed until after visual orientation changes have completed. In one embodiment, as a transition between portrait and landscape orientations are detected, audio changes from stereo to monoaural so that audio direction to speaker location transition may blend with visual image changes. For example, upon detection of a change of visual orientation, audio presentation changes to monoaural presentation, then after visual orientation image presentation change is complete, audio is presented with the new audio orientation applied.

At step 66 a determination is made of whether an audio orientation change has occurred in the absence of a visual orientation change. As an example, if multiple individuals are viewing a display from multiple directions, the audio orientation may be undetermined. In such an instance, monoaural audio presentation may replace stereo audio presentation. Alternatively, in an instance where a display presents visual images at a visual orientation that is different than the audio orientation of a viewer of a display, such as based upon an image captured of the viewer, the audio orientation may change to present stereo left and right relative to the viewer's location instead of relative to the image orientation. If a change in audio orientation is detected, the process continues to step 62 to present the audio according to the new orientation. If no change is detected, the process returns to step 64 to continue to monitor visual and audio orientation changes.

Although the present invention has been described in detail, it should be understood that various changes, substitutions and alterations can be made hereto without departing from the spirit and scope of the invention as defined by the appended claims.

1. An information handling system comprising:
a planar housing having four corners;
processing components integrated in the planar housing and operable to process audio visual information, the audiovisual information including stereo audio stored as left channel audio and right channel audio;
a display integrated in the planar housing and interfaced with the processing components to present the audiovisual as visual images;
plural speakers integrated in the planar housing and interfaced with the processing components to present the audiovisual information as audible sounds, at least one speaker located in each corner of the planar housing;
one or more orientation sensors interfaced with the processing components and operable to detect an orientation of the planar housing; and
an audio system interfaced with the processing components and the plural speakers, the audio system selecting a first speaker to present the left channel audio and a second speaker to present the right channel audio, the first and second speakers selected based upon the detected orientation to have the first speaker in a left lower corner relative to an end user and to have the second speaker in a right lower corner relative to an end user, the audio system presenting locally-generated three dimensional effects at the remaining of the plural speakers, the audio system creating the locally-generated three dimensional effects by real time processing of the left channel audio and right channel audio.

2. The information handling system of claim 1 wherein:
the locally-generated three dimensional effects comprise a first spatialized three dimensional audio that subtracts the right channel audio from the left channel audio and delays presentation of the difference, and a second spatialized three dimensional audio that subtracts the left channel audio from the right channel audio and delays presentation of the difference; and
the audio system selects the speaker above the first speaker to present the first spatialized three dimensional audio and speaker above the second speaker to present the second spatialized three dimensional audio.

3. The information handling system of claim 2 wherein the one or more orientation sensors comprise an earth magnetic field sensor.

4. The information handling system of claim 2 wherein the one or more orientation sensors comprise an accelerometer.

5. The information handling system of claim 2 wherein the one or more orientation sensors comprise a camera aligned to capture an image of a viewing area associated with the display, the image analyzed for facial features to indicate orientation relative to the user.

6. The information handling system of claim 5 wherein the image comprises plural users, the orientation determined from the user closest to the camera.

7. The information handling system of claim 5 wherein the image comprises plural users having plural orientations relative to the camera, the audio system responding to the plural orientations by playing monoaural sound at all of the plural speakers.

8. The information handling system of claim 2 wherein the audio system further comprises a crossbar switch that selectively switches audio between the plural speakers if a change in orientation is detected.

9. The information handling system of claim 8 wherein the audio system delays for a predetermined time the switching of audio between the plural speakers in response to a change in orientation.

10. A method for presenting audiovisual information at an information handling system, the method comprising:
detecting a landscape orientation of the information handling system;
presenting visual information in the landscape orientation at a display integrated in the information handling system;
presenting stereo left channel audio information at a speaker in a lower left corner of the information handling system relative to the visual information presented in the landscape orientation;
presenting stereo right channel audio information at a speaker in a lower right corner of the information handling system relative to the visual information presented in the landscape orientation;
presenting right spatialized three dimensional audio at a speaker in an upper right corner of the information handling system relative to the visual information presented in the landscape orientation, the right spatialized three dimensional audio generated by subtracting the stereo left channel audio information from the stereo right channel audio information;
presenting left spatialized three dimensional audio at a speaker in an upper left corner of the information handling system relative to the visual information presented in the landscape orientation, the left spatialized three dimensional audio generated by subtracting the stereo right channel audio information from the stereo left channel audio information;
rotating the information handling system ninety degrees to a portrait orientation; and
in response to the rotating:
presenting the visual information in the portrait orientation at the display;
moving the presenting the left audio to a speaker in a lower left corner of the information handling system relative to the visual information presented in the portrait orientation;
moving the presenting the right audio to a speaker in a lower right corner of the information handling system relative to the visual information presented in the portrait orientation;
moving the presenting the right spatialized three dimensional audio to a speaker in the upper right corner of the information handling system relative to the visual information presented in the portrait orientation; and
moving the presenting the left spatialized three dimensional audio at a speaker in the upper left corner of the information handling system relative to the visual information presented in the portrait orientation.

11. (canceled)

12. (canceled)

13. The method of claim 10 wherein:
detecting a landscape orientation further comprises capturing an image of an end user with a camera having facial features oriented to view the display in a landscape orientation; and
rotating the information handling system ninety degrees to a portrait orientation further comprises capturing an image of an end user with the camera having facial features oriented to view the display in the portrait orientation.

14. The method of claim 10 wherein:
detecting a landscape orientation further comprises comparing the information handling system orientation relative to an Earth magnetic field sensor; and
rotating the information handling system ninety degrees further comprises detecting ninety degrees of rotation relative to the landscape orientation detected by the Earth magnetic field sensor.

15. The method of claim 10 further comprising:
delaying the in response to the rotating for a predetermined time; and
canceling the in response to the rotating if rotation from the portrait to the landscape orientation is detected within the predetermined time.

16. The method of claim 15 further comprising presenting monoaural sound from the speakers during the delaying.

17. An audio system comprising:
four speakers, each of the four speakers disposed in a corner of a portable housing;
an orientation sensor operable to detect orientation of the portable housing, the detected orientation applied to present visual information in a visual orientation;
an audio processor operable to output left audio, right audio, left spatialized three dimensional audio and right spatialized three dimensional audio, the left audio provided as left stereo channel audio from an audio source, the right audio provided as right stereo channel audio from the audio source, the left spatialized three dimensional audio generated by subtracting the right stereo channel audio from the left stereo channel audio, the right spatialized three dimensional audio generated by subtracting the left stereo channel audio from the right stereo channel audio;
a crossbar switch interfacing the four speakers and audio processor; and
an orientation manager interfaced with the crossbar switch and the orientation sensor, the orientation manager controlling the switch to direct left audio and left spatialized three dimensional audio to speakers located on a left side of the visual orientation, the orientation manager controlling the switch to direct right audio and right spatialized three dimensional audio to speakers located on a right side of the visual orientation.

18. The audio system of claim 17 wherein the orientation sensor comprises a camera operable to capture an image at a viewing position of the portable housing and to apply the image to determine the visual orientation relative to facial features captured in the camera image.

19. The audio system of claim 18 wherein the camera image includes facial features of plural visual orientations, the audio processor responding to plural visual orientations by presenting monoaural audio information.

20. The audio system of claim 17 wherein the orientation sensor comprises an Earth magnetic field sensor.
